(19) United States
(12) Patent Application Publication
(10) Pub. No.: US 2012/0147302 A1
(43) Pub. Date: Jun. 14, 2012

(54) LIQUID CRYSTAL DISPLAY DEVICE

(75) Inventors: Yutaka NAKAGAWA, Arakawa-ku (JP); Yuji Soda, Arakawa-ku (JP); Koretomo Harada, Arakawa-ku (JP)

(73) Assignee: OPTREX Corporation, Arakawa-ku (JP)

(21) Appl. No.: 13/314,488

(22) Filed: Dec. 8, 2011

(30) Foreign Application Priority Data
Dec. 13, 2010 (JP) 2010-277491

(51) Int. Cl. G02F 1/1343; G02F 1/1335

(52) U.S. Cl. 349/96; 349/144

(57) ABSTRACT

A vertical alignment type liquid crystal display, having a specific resistance within a range of from 1×10¹⁰ Ωcm to 2×10¹¹ Ωcm, and containing a liquid crystal layer sandwiched by a substrate having a front electrode on the surface and a substrate having a back electrode, wherein the liquid crystal layer is aligned perpendicular to the electrode surface when no voltage is applied, and upon application of a voltage by multiplex driving, the liquid crystal layer in pixels undergoes an alignment change to align parallel to the substrates. By using slits as pixel dividing structures provided on the front of the electrode, one pixel is divided into a plurality of sub-pixels, such that the directions of the alignment change upon application of a voltage are different between adjacent sub-pixels interposing the slits, and the sub-pixels are formed within a range of from 50 μm to 100 μm.

### BACKGROUND OF THE INVENTION

1. Field of the Invention

The present invention relates to a liquid crystal display device.

2. Discussion of Background

A liquid crystal display device is constructed by sandwiching a liquid crystal layer between a transparent substrate disposed on a viewer's side and a transparent substrate disposed on the opposite side to the viewer against such a transparent substrate. The liquid crystal layer is made of e.g. nematic phase liquid crystal (hereinafter referred to also as nematic liquid crystal). On the inner surface of each substrate, a patterned transparent electrode made of e.g. ITO (Indium Tin Oxide) is formed. Between the electrode on each substrate and the liquid crystal layer, an alignment film is formed as a liquid crystal alignment layer to realize a uniform initial alignment of liquid crystal. And, depending upon an electric filed to be applied between the electrodes, the liquid crystal layer undergoes an alignment change from the initial alignment state, whereby the polarization state of light passing through the liquid crystal layer is controlled. Further, a pair of polarizing plates are disposed on the viewer's side and its opposite side to sandwich the two substrates.

Liquid crystal display devices are classified into several modes depending upon the initial alignment state of the liquid crystal layer, the operation of liquid crystal when a voltage is applied, etc. For example, a vertical alignment (VA) mode is employed (e.g. Patent Documents 1 and 2) for a liquid display device for liquid crystal TV or for mounting on a vehicle, such as an instrumental panel for a vehicle such as an automobile.

In a vertical alignment type liquid crystal display device, a liquid crystal layer sandwiched between substrates is a liquid crystal layer having a negative dielectric anisotropy (Δ∈) which is aligned so that the initial alignment state is substantially vertical (vertical alignment) to the substrates. On the two substrates, a pair of polarizing plates are disposed usually to constitute crossed nicols by sandwiching the liquid crystal layer. When a voltage is applied to the liquid crystal layer via the electrodes, the alignment of liquid crystal changes, and the liquid crystal layer tends to be vertical to the electric field i.e. the alignment direction of liquid crystal tends to be parallel with the substrates. Accordingly, at a portion where a voltage is applied, a light-transmitting property determined by a product (Δn·d) of the refractive index anisotropy (Δn) of liquid crystal and the thickness (d) of the liquid crystal layer changes as compared with the initial alignment state of liquid crystal. A vertical alignment type liquid crystal display device utilizes such a nature that the light transmitting property changes at the portion where a voltage is applied, to carry out a desired display.

The vertical alignment type liquid crystal display device has a characteristic that it is excellent in visibility, since the contrast ratio is high as viewed from the front, and the viewing angle is wide. Accordingly, it is used for an active matrix display device having a switching element such as TFT formed for every pixel, and is widely used for e.g. TV as mentioned above.
Patent Document 1: JP-A-5-113561
Patent Document 2: JP-A-10-123576

### SUMMARY OF THE INVENTION

The vertical alignment type liquid crystal display device has excellent characteristics and is desired to be applied in a wider range. Specifically, it is desired to be applied to a passive matrix display device employing multiplex driving, which is easier to produce and has high productivity. However, at present, the application is limited, and its use is also limited. One of the reasons is a problem of inherent display irregularities during multiplex driving. And, in order to avoid such display irregularities, a high frequency driving is required. Such high frequency driving causes a restriction to the electrode resistance or to driving IC and has restricted the application range.

Further, the vertical alignment type liquid crystal display device usually has a problem such that the insulating property of the alignment film is high, it is easily electrostatically charged in an external electrostatic field to cause an abnormal display, and further such an abnormal display state is likely to prolong for a long time. For example, if such a vertical alignment type liquid crystal display device is mounted on and assembled in an image display system of e.g. TV, it is likely to be abnormally lighted by static electricity during the assembling, thus leading to such a problem that it cannot be transferred to an inspection step for a long time until the abnormal lighting state is resolved. As a method for resolving such a problem of electrostatic charge, a method of providing an earth electrode made of a transparent electrode for resolving an electrostatic field outside of the cell. However, there is a problem that such a method increases the production costs.

Further, in the case of another mode liquid crystal display device such as a STN (Super Twisted Nematic) mode liquid crystal display device, a method for resolving electrostatic charge is known by adding an ionic impurity into liquid crystal to increase the electrical conductivity of the liquid crystal layer thereby to lower the after-mentioned panel specific resistance. Such a method for lowering the panel specific resistance is simple and will not increase the production cost of the product and thus is an effective method for resolving electrostatic charge of a liquid crystal display device.

However, in the case of a vertical alignment type liquid crystal display device employing multiplex driving, it is known that an addition of an ionic impurity to the liquid crystal layer promotes the above-mentioned inherent display irregularities. Thus, it has been considered difficult to practically employ such a simple method for resolving electrostatic charge in the case of a vertical alignment type liquid crystal display device employing multiplex driving.

The present invention has been made under these circumstances. That is, it is an object of the present invention to provide a vertical alignment type liquid crystal display device suitable for multiplex driving, which makes it possible to resolve the electrostatic charge problem and whereby inherent display irregularities can be reduced.

Other objects and merits of the present invention will be made apparent from the following description.

The present invention provides a liquid crystal display device having a liquid crystal layer sandwiched by a pair of substrates having an electrode formed on their surface, wherein the liquid crystal layer is aligned substantially perpendicular to the electrode surface when no voltage is applied, and upon application of a voltage by multiplex driving, the liquid crystal layer in pixels undergoes an alignment change to be aligned parallel to the substrates, the liquid crystal layer has a specific resistance within a range of from 1×10¹⁰ Ωcm to 2×10¹¹ Ωcm, by pixel dividing structures provided on the electrode, one pixel is divided into a plurality of sub-pixels, and it is so constructed that as between adjacent sub-pixels interposing a pixel dividing structure, the directions of the alignment change of the liquid crystal layer upon application of a voltage are different, and the sub-pixels are formed with a pitch within a range of from 50 μm to 100 μm.

In the present invention, it is preferred that the number of divisions of one pixel by the pixel dividing structures is at least 4.

In the present invention, it is preferably so constructed that as between adjacent sub-pixels interposing a pixel dividing structure, the flow directions of liquid crystal in the liquid crystal layer generated by the multiplex driving are different.

In the present invention, it is preferred that the flow direction of liquid crystal in the liquid crystal layer generated by the multiplex driving is equal to the direction of the alignment change of the liquid crystal layer in the sub-pixels.

In the present invention, it is preferred that each pixel dividing structure is either a slit formed in the electrode or a projection formed on the electrode.

In the present invention, it is preferred that polarizing plates are formed, respectively, on surfaces on the sides opposite to the surfaces sandwiching the liquid crystal layer, of the pair of substrates, and the polarizing plates are disposed so that their polarizing axes are perpendicular to each other, the slit or the projection has a shape extending linearly in the pixel, and the angle between the polarizing axis of either one of the polarizing plates and the extending direction of the slit or the projection is within a range of from 40° to 50°.

According to the present invention, it is possible to provide a vertical alignment type liquid crystal display device suitable for multiplex driving, which makes it possible to resolve electrostatic charge and whereby inherent display irregularities can be reduced.

### BRIEF DESCRIPTION OF THE DRAWINGS

FIGS. 1(a) is a schematic cross-sectional view illustrating an alignment change of liquid crystal caused by application of a voltage to a liquid crystal layer in a vertical alignment type liquid crystal display device, and FIG. 1(b) is a schematic cross-sectional view illustrating generation of a flow phenomenon of liquid crystal caused by application of a voltage to the liquid crystal layer in the vertical alignment type liquid crystal display device.

FIG. 2 is an enlarged plan view schematically illustrating the flow phenomenon of liquid crystal generated in a pixel of the vertical alignment type liquid crystal display device.

FIG. 3 is a plan view of a pixel schematically illustrating a method for preventing a flow phenomenon of liquid crystal by dividing the pixel.

FIG. 4 is a view schematically illustrating a method for dividing a pixel by controlling the tilt angle of liquid crystal by forming a slit in the electrode.

FIG. 5 is a view schematically illustrating a method for dividing a pixel by controlling the tilt direction of liquid crystal by forming a projection on the electrode.

FIG. 6 is a schematic enlarged plan view illustrating a first example of a first electrode form applicable to the vertical alignment type liquid crystal display device in this embodiment.

FIG. 7 is a schematic enlarged plan view illustrating a second example of the first electrode form applicable to the vertical alignment type liquid crystal display device of this embodiment.

FIG. 8 is a schematic enlarged plan view illustrating a third example of the first electrode form applicable to the vertical alignment type liquid crystal display device of this embodiment.

FIG. 9 is a schematic enlarged plan view illustrating a fourth example of the first electrode form applicable to the vertical alignment type liquid crystal display device of this embodiment.

FIG. 10 is a schematic enlarged plan view illustrating a first example of a second electrode form applicable to the vertical alignment type liquid crystal display device of this embodiment.

FIG. 11 is a schematic enlarged plan view illustrating a second example of the second electrode form applicable to the vertical alignment type liquid crystal display device of this embodiment.

FIG. 12 is a schematic enlarged plan view illustrating a third example of the second electrode form applicable to the vertical alignment type liquid crystal display device of this embodiment.

FIG. 13 is a schematic cross-sectional view illustrating a structure of the vertical alignment type liquid crystal display device of this embodiment.

### DETAILED DESCRIPTION OF THE PREFERRED EMBODIMENTS

The present inventors have analyzed display irregularities which occur during multiplex driving of a vertical alignment type liquid crystal display device and as a result, have found the following causes.

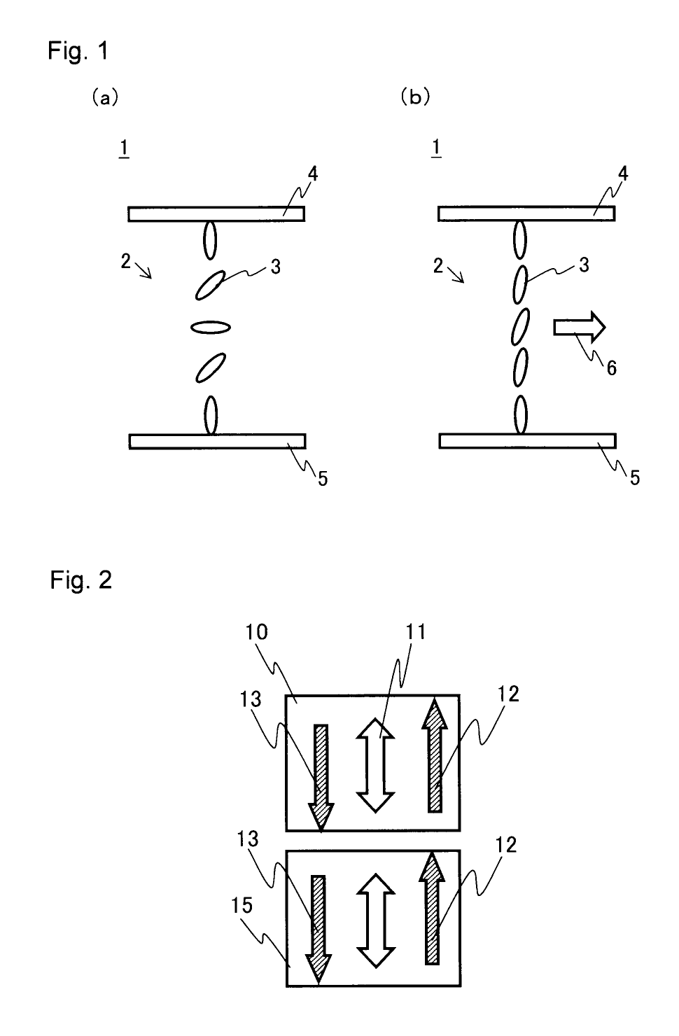

FIGS. 1(a) and (b) are views schematically illustrating a flow phenomenon formed in a liquid crystal layer when a vertical alignment type liquid crystal display device is subjected to multiplex driving. FIG. 1(a) is a schematic cross-sectional view illustrating an alignment change of liquid crystal caused by application of a voltage to a liquid crystal layer of the vertical alignment type liquid crystal display device, and FIG. 1(b) is a schematic cross-sectional view illustrating generation of a flow phenomenon of liquid crystal caused by application of a voltage to the liquid crystal layer of the vertical alignment type liquid crystal display device.

When a liquid crystal display device 1 is subjected to multiplex driving, the initial alignment of a liquid crystal layer 2 is usually controlled so that its angle of inclination (hereinafter referred to as a pretilt angle) becomes from about 0.5° to 1.5° from a vertical direction to substrates 4 and 5.

In the case of the vertical alignment type liquid crystal display device 1, a driving voltage is applied, via electrodes (not shown) on substrates 4 and 5, to a liquid crystal layer 2 in a substantially vertical alignment state as the initial alignment state. Then, as shown in FIG. 1(a), the liquid crystal 3 undergoes an alignment change so that it is tilted to a direction (tilt direction) regulated by a slight inclination in a certain direction given by the initial alignment.

In such a case, in the liquid crystal layer 2 driven by multiplex driving, by application of a voltage, liquid crystal 3 does not stay at the position at the time of the initial alignment to simply change the tilt angle. In a case where application of the voltage is stopped to let the liquid crystal 3 recover the initial alignment state, as shown in FIG. 1(b), it flows in an in-plane direction of substrates 4 and 5 depending upon the driving conditions and the tilt direction of the liquid crystal 3. FIG. 1(b) schematically shows by means of an arrow, for example, a state where the liquid crystal 3 flows in a flow direction 6 shown by the arrow. That is, in a vertical alignment type liquid crystal display device 1, it is known that liquid crystal 3 undergoes a flow phenomenon wherein the liquid crystal 3 moves from the initial alignment position.

The inherent display irregularities at the time of multiplex driving closely relate to such a flow phenomenon.

At the time of multiplex driving, if a liquid crystal flow is formed in a direction different from the direction of forming a pretilt angle imparted by the alignment film, the liquid crystal is tilted in a direction different from the direction for forming a pretilt angle, whereby display irregularities will be formed.

That is, due to the flow, realignment of liquid crystal takes place, and the liquid crystal is tilted in a direction different from the tilt direction, which will be viewed as display irregularities. Hereinafter, such realignment phenomenon of liquid crystal will be referred to as flow realignment.

The main factors influential to flow realignment may be the driving conditions for the liquid crystal display device and the viscosity of the liquid crystal.

With respect to the driving conditions, the liquid crystal tends to flow, and flow realignment is likely to take place as the number of drive scanning lines is large and as the driving frequency is low in the liquid crystal display device. And, as the viscosity of liquid crystal is low, flow realignment is likely to occur.

Liquid crystal capable of high speed response operation usually has a low viscosity, whereby display irregularities are likely to occur.

And, influences of an ionic impurity in liquid crystal are as follows.

Ions in liquid crystal present two influences. One of them is an alignment change depending on a current flowing by application of a voltage, which is called a dynamic scattering mode, wherein movement (transfer between electrodes) of ions by an electric field disturbs the liquid crystal alignment. However, the dynamic scattering mode is a state which is generated by liquid crystal having high electrical conductivity and under application of a high voltage. Accordingly, in a case where the ion concentration in liquid crystal is low, and the electrical conductivity is low, as in this embodiment, the following factor becomes predominant, and the dynamic confusion mode may be negligible.

Another factor is one caused by transfer of an ionic impurity. If flow of liquid crystal takes place by driving of a liquid crystal display device, in addition to the above-mentioned flow of liquid crystal itself, the ionic impurity in liquid crystal moves. It is considered that by the flow of the liquid crystal and the flow of the ionic impurity, a synergistic effect will be formed, whereby disturbance of the alignment in the liquid crystal layer is further increased. In fact, it has been confirmed that with liquid crystal having the ion concentration increased, the display irregularities by flow realignment are more likely to be formed.

On the basis of the foregoing analysis of causes, in the vertical alignment type liquid crystal display device in this embodiment, the following construction is adopted so that electrostatic charge and display irregularities can be reduced.

Firstly, in order to reduce electrostatic charge by application of static electricity in the liquid crystal display device, the liquid crystal display device is constructed by controlling the panel specific resistance.

The panel specific resistance is preferably within a range of from 1×10¹⁰ Ωcm to 2×10¹¹ Ωcm, more preferably within a range of from 1×10¹⁰ Ωcm to 1×10¹¹ Ωcm. The panel specific resistance defined here is a specific resistance of a liquid crystal layer evaluated in such a state that the liquid crystal layer is sandwiched between electrodes disposed, respectively, on a pair of opposing substrates by using a liquid crystal display device after its production. For example, as compared with the so-called bulk specific resistance before being applied to a liquid crystal display device, it is a property after being applied to a liquid crystal display device, and in the present invention, it is referred to as a panel specific resistance, as distinguished from the bulk specific resistance.

As a method for controlling the panel specific resistance, it is possible to realize it by introducing an ionic impurity into liquid crystal to constitute a liquid crystal display device. And, effective introduction of an ionic impurity into liquid crystal and control of the specific resistance can be realized not only by a method of directly introducing an ionic impurity but also by adding to the liquid crystal, as an additive, a compound which effectively introduces an ionic impurity into the liquid crystal, such as phenothiazine or tris(2-(2-methoxyethoxy)ethyl)amine (hereinafter referred to as TDA) represented by the following formula 1.

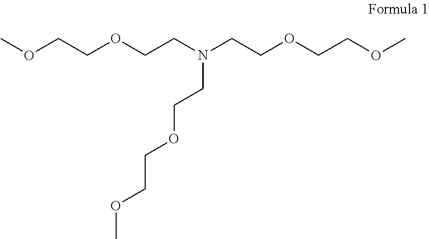

In the liquid crystal display device in this embodiment, the panel specific resistance is lowered by using liquid crystal which has been made possible to reduce electrostatic charge by improving the electrical conductivity by an addition of an ionic impurity. In addition, the liquid crystal display device in this embodiment has a construction to suppress flow of liquid crystal to be formed in the liquid crystal display device. By such constructions, in the liquid crystal display device in this embodiment, it becomes possible to realize reduction of electrostatic charge and display irregularities.

FIG. 2 is an enlarged plan view schematically illustrating a flow phenomenon of liquid crystal which is formed in pixels of a liquid crystal display device. FIG. 2 shows, as enlarged, upper and lower two pixels 10 and 15 which are lighted, of a liquid crystal display device constructed to carry out a dot matrix display.

In FIG. 2, the arrow identified by symbol 11 shows a tilt direction 11 in which liquid crystal (not shown) is tilted by application of a voltage. In the example shown in FIG. 2, a liquid crystal layer (not shown) having a substantially vertical initial alignment state to the substrates undergoes an alignment change to an upper or lower direction in the Fig. by an application of a voltage.

In such a case, as shown in FIG. 2, the direction of flow of the liquid crystal may take two directions i.e. a flow direction 12 directed upward and a flow direction 13 directed downward. And, the flow direction is likely to be slanted to one of the upper and lower two flow directions 12 and 13 in FIG. 2 in a case where the pretilt angle is different between the upper and lower substrates (not shown) sandwiching the liquid crystal layer, or as influenced by adjacent horizontal pixel lines depending upon the sequence of selected timing of the drive scanning lines in the liquid crystal display device.

For example, in a case where the flow direction of liquid crystal is slanted to the flow direction 12 in both pixels 10 and 15, a wide liquid crystal flow in one flow direction 12 will be formed which extends over lighted two pixels 10 and 15. Such a wide liquid crystal flow promotes formation of display irregularities.

Specifically, there may be a case where pixels 10 and 15 having liquid crystal flow formed upon application of a voltage, are surrounded by pixels (not shown) having no liquid crystal flow formed in a non-lighted state. In such a case, at the boundary portions within the pixels 10 and 15 with surrounding pixels, flow realignment is likely to take place, thus leading to display irregularities. In FIG. 2, display irregularities are likely to form at the upper edge of the pixel 10 or at the lower edge of the pixel 15, and side portions of the pixels 10 and 15.

Therefore, in order to reduce display irregularities in a vertical alignment type liquid crystal display device, it becomes necessary to suppress the flow phenomenon of liquid crystal. Particularly it becomes important to suppress flow of liquid crystal for every pixel.

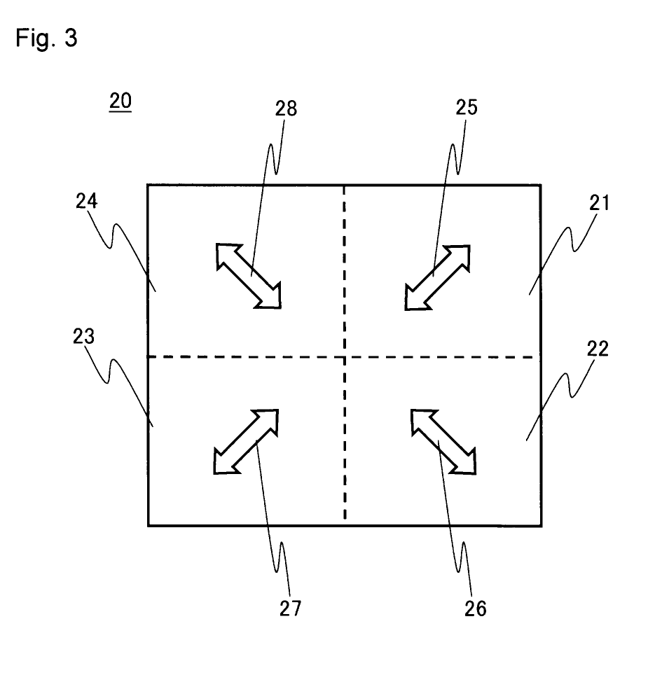

FIG. 3 is a plan view of a pixel for schematically illustrating a method for suppressing a flow phenomenon of liquid crystal by dividing the pixel.

In FIG. 3, one pixel 20 is shown as enlarged. In the pixel 20, the pixel region is divided into four, and the pretilt angle direction of liquid crystal (not shown) is controlled to be different for every sub-pixel 21, 22, 23 or 24. As a result, between adjacent sub-pixels with a boundary to divide sub-pixels 21, 22, 23 and 24, the flow direction of liquid crystal to be formed by application of a voltage is different. Accordingly, the flow directions 25, 26, 27 and 28 of liquid crystal formed by application of a voltage are different from one another.

As a result, in one pixel 20, the flow directions of liquid crystal in the respective sub-pixels 21, 22, 23 and 24 are balanced, whereby flow of liquid crystal is suppressed in the pixel 20 as a whole. And, accordingly, in the liquid crystal display device, formation of display irregularities is suppressed. Therefore, the number of divisions of one pixel is preferably at least 4.

In the vertical alignment type liquid crystal display device in this embodiment, pixels are divided to suppress flow of liquid crystal thereby to suppress formation of display irregularities. In such a case, by controlling the direction (the tilt direction) of the alignment change of liquid crystal upon application of a voltage, division of pixels is realized.

As a method for dividing a pixel by controlling the tilt direction of liquid crystal, it is preferred to provide pixel dividing structures in the pixel. For example, two preferred embodiments are available as pixel dividing structures capable of controlling the tilt direction of liquid crystal. One of them is a slit formed in an electrode which is formed on the surface of a substrate to sandwich the liquid crystal layer. The other is a projection formed on an electrode in a pixel.

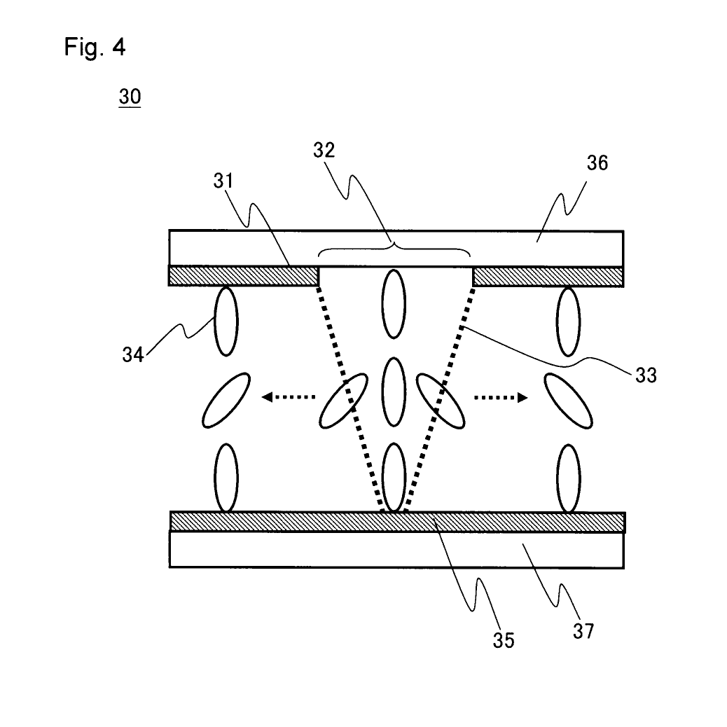

FIG. 4 is a view for schematically illustrating a method for dividing a pixel by controlling the tilt angle of liquid crystal by forming a slit in an electrode.

FIG. 4 schematically illustrates a cross-section of a liquid crystal display device having an electrode structure improved, wherein a slit 32 is formed in an electrode 31. In the vertical alignment type liquid crystal display device 30, a slit 32 is formed in the electrode 31 on one substrate 36 among a pair of substrates 36 and 37 sandwiching vertically aligned liquid crystal 34. By the formation of the slit 32, upon application of a drive voltage, an oblique electric field 33 is formed between the electrode 31 and the opposing electrode 35 on the substrate 37. By the formation of the oblique electric field 33, two regions (sub-pixels) different in the tilt direction of liquid crystal 34 are formed to interpose the slit 32 in one pixel. Accordingly, by adopting an electrode structure having mutually orthogonal two slits formed in one pixel, it is possible to divide one pixel into four sub-pixels.

As a result, between the adjacent sub-pixels with a slit 32 interposed to divide sub-pixels, the tilt angle of liquid crystal formed upon application of a voltage is different, and the flow direction of liquid crystal thereby formed is accordingly different between the adjacent sub-pixels.

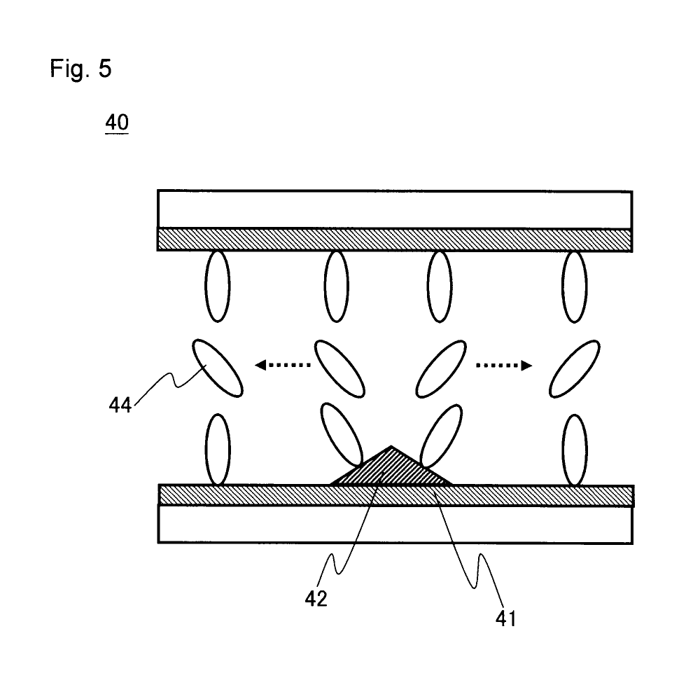

FIG. 5 is a view schematically illustrating a method for dividing a pixel by controlling the tilt direction of liquid crystal by forming a projection on an electrode. FIG. 5 schematically illustrates a cross-section of a liquid crystal display device 40 having an electrode structure improved, wherein a projection 42 is formed on the electrode 41. By using the electrode having such a projection 42 formed, in one pixel, two regions (sub-pixels) different in the tilt angle of liquid crystal 44 are formed with the projection 42 interposed between them.

As a result, between the adjacent sub-pixels with the projection 42 interposed to divide sub-pixels, the tilt direction of liquid crystal formed upon application of a voltage is different, and the flow direction of liquid crystal formed upon application of a voltage is accordingly different between the adjacent sub-pixels.

Further, in a case where in a projection 42 to be formed, the symmetry is not good, the pretilt angle of liquid crystal 44 varies as between both sides interposing the projection 42, whereby the symmetry of flow of liquid crystal 44 tends to deteriorate. As a result, the balance in the flow of liquid crystal tends to be maintained as between sub-pixels divided with the projection 42 interposed. Therefore, the method for dividing a pixel by forming a slit in an electrode is more preferred, whereby the shape control can more easily be carried out.

Now, a preferred electrode form to constitute the vertical alignment type liquid crystal display device in this embodiment will be described. The electrode for the vertical alignment type liquid crystal display device in this embodiment preferably has slits effective for suppressing the flow realignment phenomenon.

Firstly, a first electrode form for the liquid crystal display device in this embodiment to divide one pixel into sub-pixels thereby to divide the flow of liquid crystal into different directions to suppress the flow of liquid crystal in the pixel as a whole.

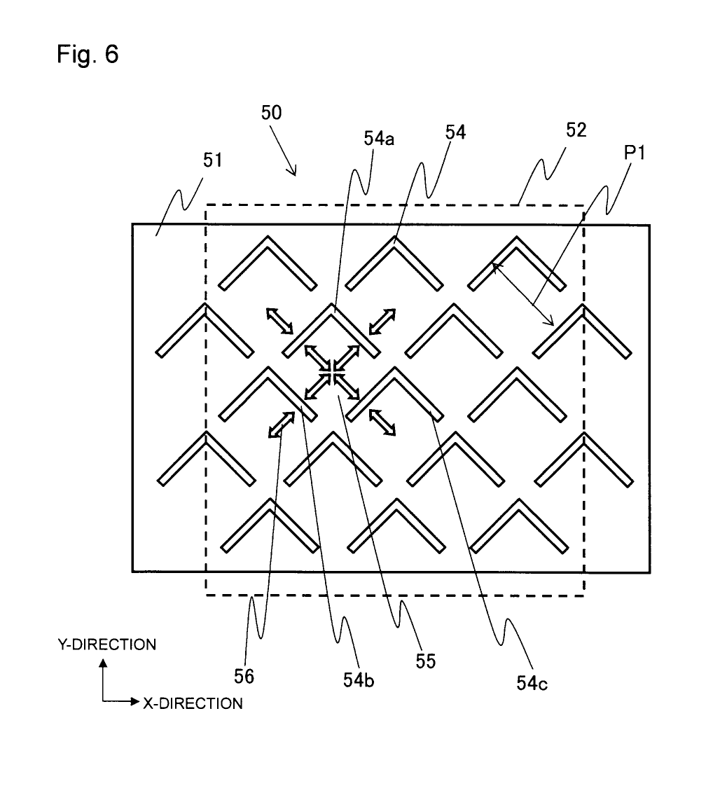

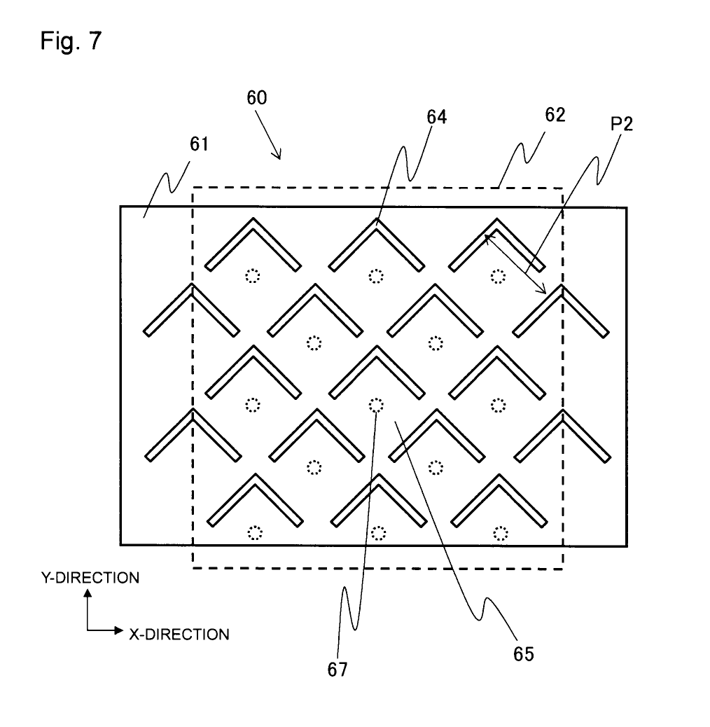

FIG. 6 is a schematic enlarged plan view illustrating a first example of the first electrode form applicable to the vertical alignment type liquid crystal display device in this embodiment.

As shown in FIG. 6, a front electrode 51 and a back electrode 52 are, respectively, formed on a pair of substrates (not shown) sandwiching a liquid crystal layer (not shown). And, their overlapping portion constitutes one pixel 50. Among the front electrode 51 and the back electrode 52 formed on the substrates (not shown), on the front electrode 51, slits 54 bent at a right angle in a dogleg shape are formed.

As shown in FIG. 6, slits 54 are formed, for example, so that the forward ends of the bent portions are directed to one direction, e.g. to the Y-direction of the pixel, and a plurality of such slits are disposed in the X- and Y-directions in one pixel 50. And, lines of slits 54 arrayed in the Y-direction of the pixel 50, are formed so that as between the adjacent lines, the pitch of slits 54 is displaced by a half pitch. As a result, a sub-pixel 55 is formed as defined by three slits 54a, 54b and 54c. A preferred pitch P1 for forming sub-pixels 55 is from 50 μm to 100 μm. Further, the pitch for forming sub-pixels is a pitch between the portions extending in the same direction of slits 54 and is a pitch in a direction vertical to the direction in which such portions extend. The pitch becomes a pitch for forming slits 54 in an oblique direction to the pixel 50.

By adopting such a slit structure, flow directions 56 of liquid crystal formed in the sub-pixel 55 are finely divided, and at the same time, they have a good balance among themselves. As a result, liquid crystal flows in the sub-pixel 55 are balanced out, so that the flow of liquid crystal is suppressed in the pixel 50 as a whole.

FIG. 7 is a schematic enlarged plan view illustrating a second example of the first electrode form applicable to the vertical alignment type liquid crystal display device in this embodiment.

In the second example of the electrode form shown in FIG. 7, in the same manner as in the above-described first example, slits 64 bent at a right angle in a dogleg shape are provided on the front electrode 61 constituting a pixel 60 with the same pitch P2 as in the first example. And, on the back electrode 62, a circular slit 67 is formed so that it is located in the vicinity of the center of a sub-pixel 65. By forming such a circular slit 67, alignment of liquid crystal (not shown) will be stabilized, whereby alignment turbulence to cause display irregularities tends to scarcely occur.

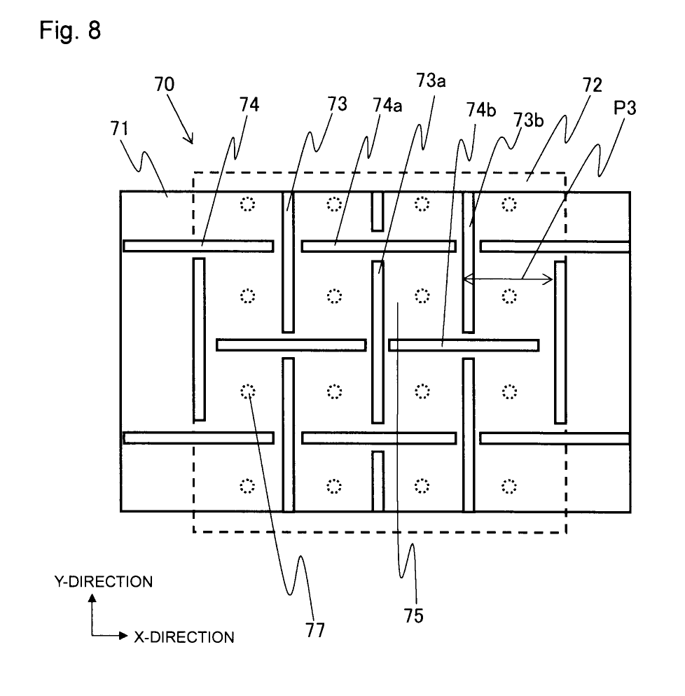

FIG. 8 is a schematic enlarged plan view illustrating a third example of the first electrode form applicable to the vertical alignment type liquid crystal display device in this embodiment.

As shown in FIG. 8, a front electrode 71 and a back electrode 72 are, respectively, formed on a pair of substrates (not shown) sandwiching a liquid crystal layer (not shown). And, their overlapping portion constitutes one pixel 70.

Among the front electrode 71 and the back electrode 72 formed on the substrates (not shown), on the front electrode 71, a plurality of linear slits 73 extending in the Y-direction of the pixel 70 and a plurality of linear slits 74 extending in the X-direction are formed in combination so that they do not intersect each other. As a result, as shown in FIG. 8, a sub-pixel 75 is formed as defined in a square shape by four slits 73a, 73b, 74a and 74b. A preferred pitch P3 for forming sub-pixels 75 is from 50 μm to 100 μm. Further, the pitch for forming sub-pixels 75 is a pitch between slit portions extending in the same direction as shown in FIG. 8 and is a pitch in a direction vertical to the direction in which the slit portions extend.

And, on the back electrode 72, a circular slit 77 is formed so that it is located in the vicinity of the center of the sub-pixel 75. By forming such a circular slit 77 in addition to the linear slits 73 and 74, the alignment of liquid crystal (not shown) will be stabilized, and alignment disturbance to cause display irregularities tends to scarcely occur.

By adopting such a slit structure, flow directions of liquid crystal formed in the sub-pixel 75 will be finely divided, and at the same time, they have a good balance among themselves. As a result, the liquid crystal flows in the sub-pixel 75 are balanced out, whereby the flow of liquid crystal is suppressed in the pixel 70 as a whole.

Further, in the third example of the first electrode form applicable to the vertical alignment type liquid crystal display device in this embodiment, shown in FIG. 8, circular slits 77 are formed in the back electrode 72. However, in this third example, the slit structure may be constructed by using only linear slits 73 and 74 in the front electrode 71 without forming circular slits 77. Even by such a structure, the flow directions of liquid crystal in the sub-pixel 75 may be finely divided, whereby the flow of liquid crystal and display irregularities can be suppressed.

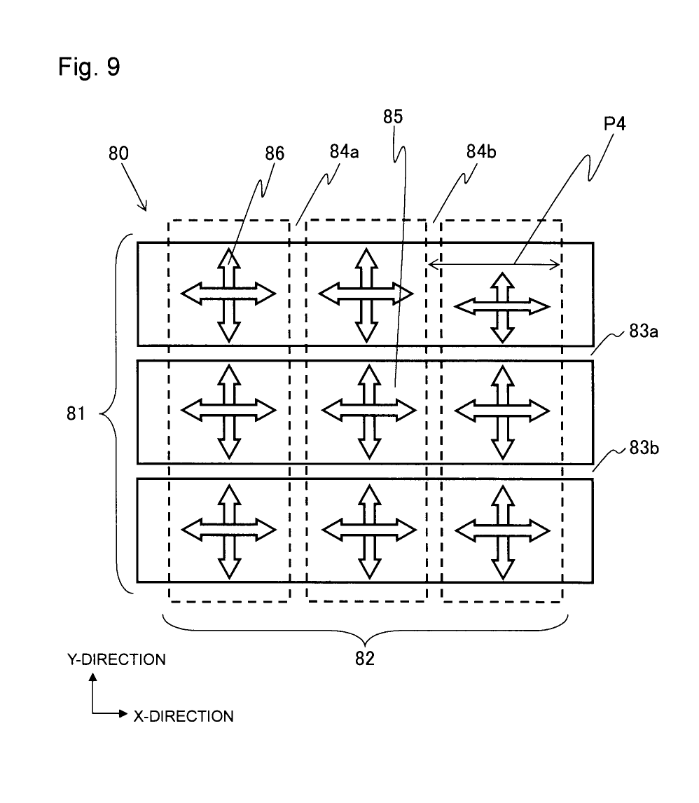

FIG. 9 is a schematic enlarged plan view illustrating a fourth example of the first electrode form applicable to the vertical alignment type liquid crystal display device in this embodiment.

As shown in FIG. 9, a front electrode 81 and a back electrode 82 are, respectively, formed on a pair of substrates (not shown) sandwiching a liquid crystal layer (not shown). And, their overlapping portion constitutes one pixel 80. The fourth example of the first electrode form applicable to the vertical alignment type liquid crystal display device in this embodiment, has a structure wherein the pixel is divided by orthogonal parallel slits.

As shown in FIG. 9, on the front electrode 81, slits 83a and 83b linearly extending in the X-direction are formed, and in this example, the front electrode is divided into three stripe electrode portions. On the back electrode 82, slits 84a and 84b linearly extending in the Y-direction are formed, and in this example, the back electrode is divided into three stripe electrode portions. Thus, in the example shown in FIG. 9, one pixel 80 is constituted by nine sub-pixels. And, for example, a sub-pixel 85 has a structure defined by four linear slits i.e. slits 83a and 83b extending in the X-direction and slits 84a and 84b extending in the Y-direction. Other sub-pixels likewise have a structure defined by four linear slits.

A preferred pitch P4 for forming sub-pixels is from 50 μm to 100 μm. Further, the pitch for forming sub-pixels is a pitch between slits extending in the same direction, as shown in FIG. 9.

By adopting such a slit structure, for example, flow directions 86 of liquid crystal formed in a sub-pixel 85 are finely divided, and at the same time, they have a balance among themselves. As a result, the liquid crystal flows in a sub-pixel 85 are balanced out. Likewise, in other sub-pixels, flows of liquid crystal are balanced out, whereby the flow of liquid crystal is suppressed in the pixel 80 as a whole.

Now, a second electrode form for the liquid crystal display device in this embodiment will be described. In the second electrode form for the liquid crystal display device in this embodiment, on electrodes constituting a pixel, linear parallel slits are provided, so that flows of liquid crystal are made symmetrical on both sides of each slit. As a result, even if flows of liquid crystal take place, they are made to coincide with original tilt directions of liquid crystal thereby to reduce the influence of the flows of liquid crystal.

And, in this second electrode form, at the same time, one pixel is divided into sub-pixels by the slits, whereby it becomes possible to finely divide the flows of liquid crystal in different directions thereby to suppress the flow of liquid crystal in the pixel as a whole.

Thus, by the second electrode form for the liquid crystal display device in this embodiment, it is possible to reduce flow realignment.

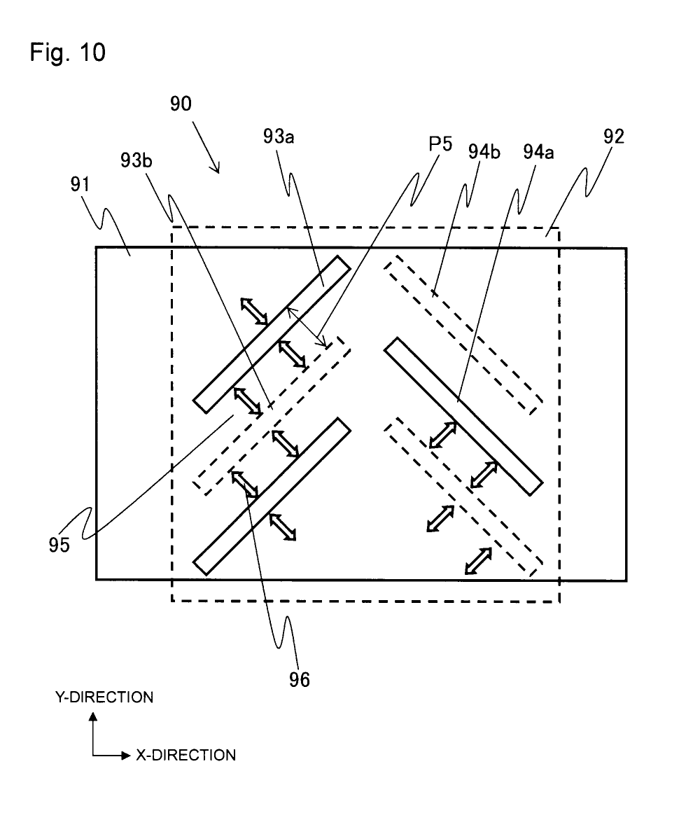

FIG. 10 is a schematic enlarged plan view illustrating a first example of the second electrode form applicable to the vertical alignment type liquid crystal display device in this embodiment.

In the first example of the second electrode form, a front electrode 91 and a back electrode 92 are, respectively, formed on a pair of substrates (not shown) sandwiching a liquid crystal layer (not shown).

And, as shown in FIG. 10, in one pixel 90, a plurality of parallel slits 93a, 93b, 94a and 94b are formed on the front electrode 91 and the back electrode 92. Among the plurality of parallel slits, e.g. parallel slits 93a and 93b are disposed at equal distances as clockwise inclined at 45° from the Y-direction, and parallel slits 94a and 94b are disposed at equal distances as counterclockwise inclined at 45° from the Y-direction. As a result, in one pixel 90, parallel slits 93a and 93b and parallel slits 94a and 94b are disposed so that they are respectively lined up in the Y-direction. And, a plurality of such lines are disposed in one pixel 90.

Here, the forming angles for the parallel slits 93a, 93b, 94a and 94b can be set to be optimum in consideration of the direction of liquid crystal. By carrying out the optimum forming angle setting to let the flow direction of liquid crystal and the tilt direction of liquid crystal by driving agree to each other, it is possible to reduce the influence of the flow of liquid crystal over the liquid crystal alignment.

And, parallel slits 93a, 93b, 94a and 94b are formed on both the front electrode 91 and the back electrode 92. For example, parallel slits 93a and 94a are formed on the front electrode 91, and adjacent parallel slits 93b and 94b are formed on the back electrode 92. That is, linear parallel slits 93a and 93b and parallel slits 94a and 94b, which respectively extend in the same direction, are constructed so that ones formed on the front electrode 91 and ones formed on the back electrode 92 are disposed alternately in the Y-direction in one pixel 90. Further, also in the X-direction, adjacent parallel slits extending in different directions are disposed so that one is formed on the front electrode 91 and the other is formed on the back electrode 92.

And, the first example of the second electrode form applicable to the vertical alignment type liquid crystal display device in this embodiment has a construction wherein a pixel is divided by a plurality of parallel slits extending in the same direction. At that time, a preferred pitch P5 for forming sub-pixels is from 50 μm to 100 μm. Here, the pitch for forming sub-pixels is a pitch for forming slits extending in the same direction in one pixel, as shown in FIG. 10.

In the first example of the second electrode form, by adopting the slit structure as described above, for example, the flow directions 96 of liquid crystal formed in a sub-pixel 95 are finely divided, and at the same time, they are mutually balanced. As a result, the flows of liquid crystal in a sub-pixel 95 will be balanced out. Likewise, also in other sub-pixels, the flows of liquid crystal are balanced out, and the flow of liquid crystal is suppressed in a pixel 90 as a whole.

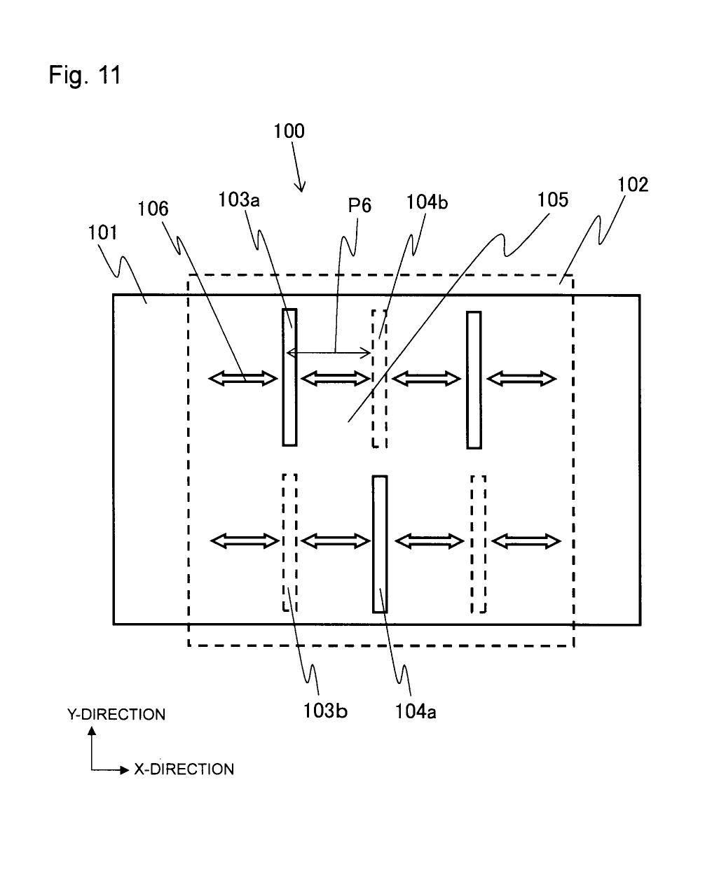

FIG. 11 is a schematic enlarged plan view illustrating a second example of the second electrode form applicable to the vertical alignment type liquid crystal display device in this embodiment.

In the second example of the second electrode form, a front electrode 101 and a back electrode 102 are, respectively, formed on a pair of substrates (not shown) sandwiching a liquid crystal layer (not shown).

And, as shown in FIG. 11, in one pixel 100, a plurality of parallel slits 103a, 103b, 104a and 104b extending in the Y-direction are formed on the front electrode 101 and the back electrode 102. And, the plurality of parallel slits 103a, 103b, 104a and 104b are, respectively, disposed at equal distances in the X-direction and the Y-direction, and they are disposed so that they are, respectively, lined up in the two directions.

And, parallel slits 103a, 103b, 104a and 104b are formed on both the front electrode 101 and the back electrode 102. For example, parallel slits 103a and 104a are formed on the front electrode 101, and parallel slits 103b and 104b adjacent thereto are formed on the back electrode 102. That is, in a line in the X-direction of parallel slits 103a, 103b, 104a and 104b, ones formed on the front electrode 101 and ones formed on the back electrode 102 are alternately disposed. Likewise, also in a line formed in the Y-direction, ones formed on the front electrode 101 and ones formed on the back electrode 102 are alternately disposed.

And, the second example of the second electrode form applicable to the vertical alignment type liquid crystal display device in this embodiment, has a structure wherein a pixel is divided by a plurality of parallel slits extending in the same direction. In the example shown in FIG. 11, one sub-pixel 105 is formed between parallel slits 103a and 104b adjacent in the X-direction, and another sub-pixel is formed between parallel slits 103b and 104a. That is, a sub-pixel is formed which is defined by two parallel slits adjacent in the X-direction.

At that time, a preferred pitch P6 for forming sub-pixels is from 50 μm to 100 μm. Here, the pitch for forming sub-pixels is a pitch in the X-direction of the slits extending in the same direction in one pixel, as shown in FIG. 11.

In the second example of the second electrode form, by adopting the slit structure as described above, for example, the flow directions 106 of liquid crystal formed in a sub-pixel 105 will be finely divided, and at the same time, they are mutually balanced. As a result, in a sub-pixel 105, the flows of liquid crystal are balanced out. Likewise, in other sub-pixels, the flows of liquid crystal are balanced out, and the flow of liquid crystal will be suppressed in a pixel 100 as a whole.

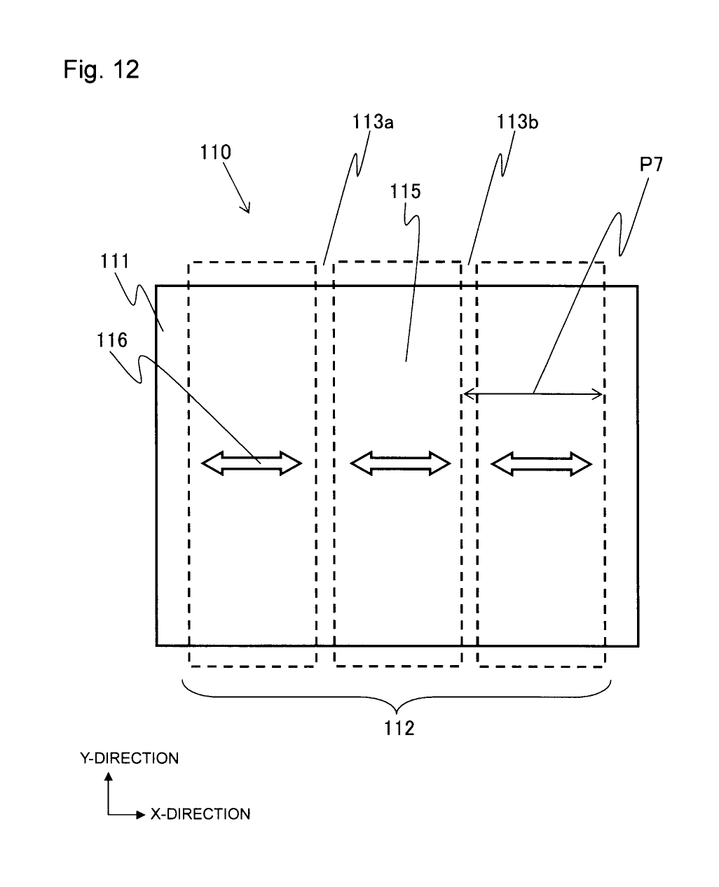

FIG. 12 is a schematic enlarged plan view illustrating a third example of the second electrode form applicable to the vertical alignment type liquid crystal display device in this embodiment.

A front electrode 111 and a back electrode 112 are, respectively, formed on a pair of substrates (not shown) sandwiching a liquid crystal layer (not shown). And, as shown in FIG. 12, their overlapping portion constitutes one pixel 110. The third example of the second electrode form applicable to the vertical alignment type liquid crystal display device in this embodiment, has a construction wherein parallel slits are formed on one of the front electrode 111 and the back electrode 112, and by such parallel slits, the pixel is divided into sub-pixels.

Specifically, as shown in FIG. 12, on the back electrode 112, parallel slits 113a and 113b linearly extending in the Y-direction are formed. In this example, the back electrode 112 has such a construction that it is divided into three stripe electrode portions by two parallel slits 113a and 113b. Therefore, as shown in FIG. 12, one pixel 110 is constituted by three sub-pixels. And, for example, a sub-pixel 115 has a structure defined by two linear parallel slits 113a and 113b. Also other pixels have a structure defined by two linear parallel slits.

A preferred pitch P7 for forming sub-pixels is from 50 μm to 100 μm. Here, the pitch for forming sub-pixels is a pitch for forming parallel slits, as shown in FIG. 12.

By such an electrode structure having parallel slits 113a and 113b, for example, the flow directions 116 of liquid crystal formed in a sub-pixel 115 will be finely divided, and at the same time, they are mutually balanced. As a result, in the sub-pixel 115, the flows of liquid crystal are balanced out. Likewise, also in other sub-pixels, the flows of liquid crystal are balanced out, and the flow of liquid crystal is suppressed in a pixel 110 as a whole.

Now, the vertical alignment type liquid crystal display device in this embodiment will be described to which electrodes having the above-described structure are applied.

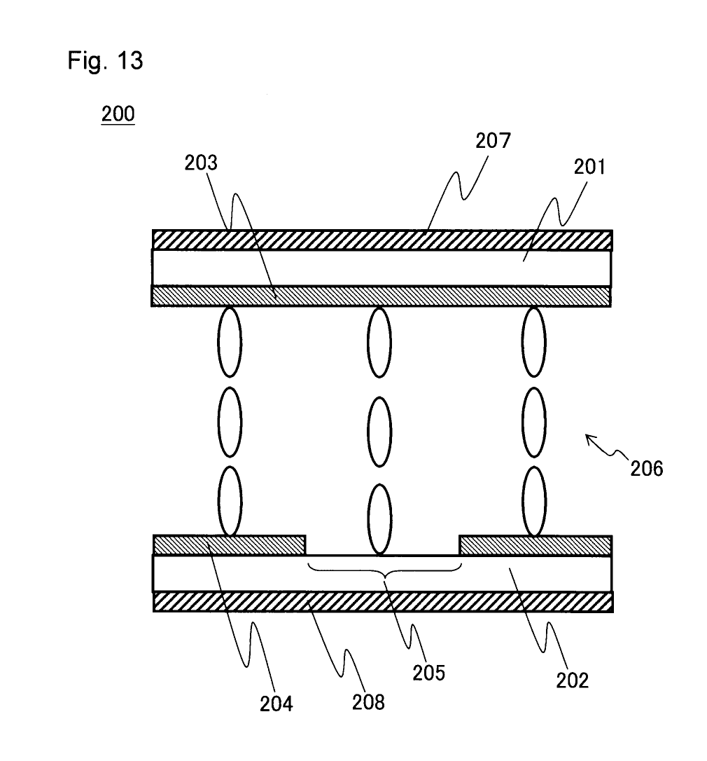

FIG. 13 is a schematic cross-sectional view illustrating a construction of the vertical alignment type liquid crystal display device in this embodiment.

The liquid crystal display device 200 in this embodiment is a vertical alignment type liquid crystal display device 200 capable of multiplex driving. And, on the surfaces of a pair of substrates 201 and 202, for example, electrodes 203 and 204 applicable to the vertical alignment type liquid crystal display device in this embodiment, as described by using FIGS. 6 to 12, are disposed. For example, in FIG. 13, electrodes 203 and 204 have a slit 205. Electrodes 203 and 204 may be formed by patterning ITO (Indium Tin Oxide). Here, in FIG. 13, a structure of electrode 203, electrode 204 and a slit 205 is schematically shown. The liquid crystal layer 206 is made of liquid crystal having the electrical conductivity increased by introducing an ionic impurity.

For the substrates 201 and 202 sandwiching the liquid crystal layer 206, it is possible to use transparent substrates such as glass substrates. As transparent substrates, substrates made of a material having a high transmittance to visible light may, for example, be used. Specifically, inorganic glass such as alkali glass, alkali-free glass and quartz glass may be mentioned as examples of the above glass substrates. Further, substrates made of transparent resins such as a polyester, a polycarbonate, a polyether, a polysulfone, a polyether sulfone, a polyvinyl alcohol and a fluorinated polymer such as a polyvinyl fluoride may be mentioned as other examples. It is preferred to use a substrate made of inorganic glass from the viewpoint of high rigidity.

The thickness of the substrates sandwiching the liquid crystal layer 206 is not particularly limited, but it is usually from 0.2 mm to 1.5 mm, preferably from 0.3 mm to 1.1 mm. To such a substrate, a surface treatment layer made of an inorganic or organic substance may be formed as the case requires, for the purpose of e.g. preventing alkali elution, improving adhesion, preventing reflection or providing a hard coat.

On the electrodes 203 and 204 on the substrates 201 and 202, an alignment film (not shown) is formed for vertical alignment of the liquid crystal layer 206. Such an alignment film may be formed, for example, by using an alignment film material (trade name: A-8530) manufactured by Chisso Corporation. That is, such an alignment film material is formed into a film on a substrate by a flexo printing method, and such a substrate is fired at 180° C. As a result, it is formed as an alignment film having a thickness of about 600 Å on electrodes 203 and 204 of substrates 201 and 202.

Here, the alignment film to be used for the liquid crystal display device in an embodiment of the present invention may be one having a function to vertically align liquid crystal, and it is possible to use one other than the above exemplified one.

Specifically, it may be suitably selected depending upon the specification of the liquid crystal display device. For example, it is possible to use a polyimide, a polyamide or a silane coupling agent having a long chain alkyl group.

In the liquid crystal display device 200, a pair of polarizing plates 207 and 208 are disposed to sandwich substrates 201 and 202.

In the liquid crystal display device 200 in this embodiment, as the polarizing plate 207, a polarizing plate manufactured by Polatechno Co., Ltd. (trade name: SHC-13UL2SZ9) may be used, and as the polarizing plate 208, another polarizing plate manufactured by the same company (trade name: 000R220N-SH38L2S) may be used. In such a case, they are disposed so that a counterclockwise angle θ1 from the reference axis as viewed from the viewer's side to the absorption axis of the polarizing plate 207 becomes 45°, and a counterclockwise angle θ2 from the above reference axis to the absorption axis of the polarizing plate 208 becomes 135°. The polarizing axes of the polarizing plates 207 and 208 are orthogonal to each other. Then, on the polarizing plates 207 and 208, protective resin films (not shown) are, respectively, formed.

Here, a slit 205 of the electrode 204 applicable to the vertical alignment type liquid crystal display device 200 in this embodiment, has the same shape as one described by using FIGS. 6 to 12. That is, each slit has a shape extending linearly or has a portion having a shape extending linearly. It is preferred that the liquid crystal display device 200 is constructed so that the angle between the linearly extending direction of the slit, etc., and the polarization axis of one of the polarizing plates 207 and 208 is within a range of from 40° to 50°. And, it is more preferred that such an angle is 45°. When the vertical alignment type liquid crystal display device 200 has such a construction, the tilt direction of the liquid crystal layer 206 and the liquid crystal flow direction of the liquid crystal layer 206 agree to each other, and it is possible to suppress flow realignment in the liquid crystal layer 206.

### EXAMPLES

Now, the embodiment of the present invention will be described in further detail with reference to Examples. Further, Comparative Examples relating to the embodiment of the present invention will also be described. However, it should be understood that the present invention is by no means restricted by these Examples.

### Preparation of Liquid Crystal

Liquid crystal to be used in Examples of the present invention was prepared. As base liquid crystal, a liquid crystal composition was used which was made of nematic liquid crystal and which had a liquid crystal temperature range of from −40° C. to +102° C., a dielectric constant anisotropy (Δ∈) at 25° C. being −4.5 and a refractive index anisotropy at 25° C. being 0.180.

To this base liquid crystal, TDA was added to be 10 ppm to prepare liquid crystal 1. To the base liquid crystal, TDA was added to be 50 ppm to prepare liquid crystal 2. TDA was added to be 500 ppm to prepare liquid crystal 3.

### Evaluation of Display Irregularities

Evaluation of display irregularities was carried out by using vertical alignment type liquid crystal display devices obtained in Examples 1 to 8 and Comparative Examples 1 to 4 described hereinafter.

For the evaluation of display irregularities, in a liquid crystal display device to be evaluated, the driving waveform was fixed to 1/32 duty and ⅙ bias, and display was carried out by changing the frame frequency to be 25 Hz, 50 Hz, 100 Hz, 150 Hz and 200 Hz, whereby evaluation was made by the following standards.

◯: Within a wide drive voltage range, display can be made free from display irregularities.

Δ: By limiting the drive voltage range, display can be made free from display irregularities.

x: Even if the drive voltage condition is limited, display free from display irregularities is impossible.

### Example 1

The above liquid crystal 2 was applied to the vertical alignment type liquid crystal display device capable of multiplex driving in this embodiment as described above, whereby a liquid crystal display device of Example 1 was prepared. The electrode structure of a pixel of the liquid crystal display device of Example 1 was made to be the same as the first example of the second electrode form applicable to the vertical alignment type liquid crystal display device in this embodiment, as shown in FIG. 10. In such a case, the size of one pixel was 0.39 mm square, the pitch for forming sub-pixels was 80 μm, and each linear slit width was made to be 10 μm. The panel specific resistance was 4.6×10¹⁰ Ωcm. Using the vertical alignment type liquid crystal display device of Example 1, static electricity was applied to the substrate surface for displaying the liquid crystal layer, whereby the time until electrostatic charge was resolved, was 5 seconds and thus was found to be a very short time.

Using this vertical alignment type liquid crystal display device of Example 1, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 2

The above liquid crystal 2 was applied to the vertical alignment type liquid crystal display device capable of multiplex driving in this embodiment as described above, whereby a liquid crystal display device of Example 2 was prepared. The electrode structure of a pixel in the liquid crystal display device of Example 2 was made to be the same as the first example of the first electrode form applicable to the vertical alignment type liquid crystal display device in this embodiment as shown in FIG. 6. In such a case, the size of one pixel was 0.39 mm square, the pitch for forming sub-pixels was 80 μm, and the width of a linearly extending slit portion of a bent slit was 10 μm. The panel specific resistance was 4.6×10¹⁰ Ωcm.

Using the vertical alignment type liquid crystal display device of Example 2, static electricity was applied to the substrate surface for displaying the liquid crystal layer, whereby the time until the electrostatic charge was resolved, was 4 seconds and thus was found to be a very short time.

By using this vertical alignment type liquid crystal display device of Example 2, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 3

The above liquid crystal 2 was applied to the vertical alignment type liquid crystal display device capable of multiplex driving in this embodiment as described above, whereby a liquid crystal display device of Example 3 was prepared. The electrode structure of a pixel in the liquid crystal display device of Example 3 was made to be the same as the second example of the second electrode form applicable to the vertical alignment type liquid crystal display device in this embodiment as shown in FIG. 11. In such a case, the size of one pixel was 0.39 mm square, the pitch for forming sub-pixels was 80 μm, and the width of a linear slit was 10 μm. The panel specific resistance was 4.6×10¹⁰ Ωcm.

By using the vertical alignment type liquid crystal display device of Example 3, static electricity was applied to the substrate surface for displaying the liquid crystal layer, whereby the time until the electrostatic charge was resolved, was 5 seconds and thus was found to be a very short time.

By using this vertical alignment type liquid crystal display device of Example 3, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 4

The above liquid crystal 2 was applied to the vertical alignment type liquid crystal display device capable of multiplex driving in this embodiment as described above, whereby a liquid crystal display device of Example 4 was prepared. The electrode structure of a pixel in the liquid crystal display device of Example 4 was made to be the same as the fourth example of the first electrode form applicable to the vertical alignment type liquid crystal display device in this embodiment as shown in FIG. 9. In such a case, the size of one pixel was 0.39 mm square, the pitch for forming sub-pixels was 80 μm, and the width of a linear slit was 10 μm. The panel specific resistance was 4.6×10¹⁰ Ωcm.

By using the vertical alignment type liquid crystal display device of Example 4, static electricity was applied to the substrate surface for displaying the liquid crystal layer, whereby the time until the electrostatic charge was resolved was 3 seconds and thus was found to be a very short time.

By using this vertical alignment type liquid crystal display device of Example 4, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 5

The above liquid crystal 1 was applied to the vertical alignment type liquid crystal display device capable of multiplex driving in this embodiment as described above, whereby a liquid crystal display device of Example 5 was prepared. The electrode structure of a pixel in the liquid crystal display device of Example 5 was made to be the same as the fourth example of the first electrode form applicable to the vertical alignment type liquid crystal display device in this embodiment as shown in FIG. 9. In such a case, the size of one pixel was 0.39 mm square, the pitch for forming sub-pixels was 80 μm, and the width of a linear slit was 10 μm. The panel specific resistance was 1.0×10¹¹ Ωcm.

By using the vertical alignment type liquid crystal display device of Example 5, static electricity was applied to the substrate surface for displaying the liquid crystal layer, whereby the time until the electrostatic charge was resolved was 15 seconds and thus was found to be a short time.

By using this vertical alignment type liquid crystal display device of Example 5, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 6

The above liquid crystal 3 was applied to the vertical alignment type liquid crystal display device capable of multiplex driving in this embodiment as described above, whereby a liquid crystal display device of Example 6 was prepared. The electrode structure of a pixel in the liquid crystal display device of Example 6 was made to be the same as the fourth example of the first electrode form applicable to the vertical alignment type liquid crystal display device in this embodiment as shown in FIG. 9. In such a case, the size of one pixel was 0.39 mm square, the pitch for forming sub-pixels was 100 μm, and the width of a linear slit was 10 μm. The panel specific resistance was 1.1×10¹⁰ Ωcm.

By using the vertical alignment type liquid crystal display device of Example 6, static electricity was applied to the substrate surface for displaying the liquid crystal layer, whereby the time until the electrostatic charge was resolved was less than 1 second and thus was found to be a very short time.

By using this vertical alignment type liquid crystal display device of Example 6, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 7

The above liquid crystal 2 was applied to the vertical alignment type liquid crystal display device capable of multiplex driving in this embodiment as described above, whereby a liquid crystal display device of Example 7 was prepared. The electrode structure of a pixel in the liquid crystal display device of Example 7 was made to be the same as the third example of the first electrode form applicable to the vertical alignment type liquid crystal display device in this embodiment as shown in FIG. 8. In such a case, the size of one pixel was 0.39 mm square, the pitch for forming sub-pixels was 80 μm, and the width of a linear slit was 10 μm. The panel specific resistance was 4.6×10¹⁰ Ωcm.

By using the vertical alignment type liquid crystal display device of Example 7, static electricity was applied to the substrate surface for displaying the liquid crystal layer, whereby the time until the electrostatic charge was resolved was 3 seconds and thus was found to be a very short time.

By using this vertical alignment type liquid crystal display device of Example 7, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Example 8

The above liquid crystal 2 was applied to the vertical alignment type liquid crystal display device capable of multiplex driving in this embodiment as described above, whereby a liquid crystal display device of Example 8 was prepared. The electrode structure of a pixel in the liquid crystal display device of Example 8 was made to be the same as the fourth example of the first electrode form applicable to the vertical alignment type liquid crystal display device in this embodiment as shown in FIG. 9. In such a case, the size of one pixel was 0.39 mm square, the pitch for forming sub-pixels was 50 μm, and the width of a linear slit was 10 μm. The panel specific resistance was 4.6×10¹⁰ Ωcm.

By using the vertical alignment type liquid crystal display device of Example 8, static electricity was applied to the substrate surface for displaying the liquid crystal layer, whereby the time until the electrostatic charge was resolved was 4 seconds and thus was found to be a very short time.

By using this vertical alignment type liquid crystal display device of Example 8, the above-described evaluation of display irregularities was carried out.

As a result of the evaluation, in the evaluation at a frame frequency of 25 Hz, the evaluation result was x, in the evaluation at a frame frequency of 50 Hz, the evaluation result was Δ, and in the evaluation at a frame frequency of 100 Hz, 150 Hz and 200 Hz, each of the evaluation results was ◯.

### Comparative Example 1

A liquid crystal display device of Comparative Example 1 was prepared by applying the above liquid crystal 1 to a conventional vertical alignment type liquid crystal display device having the same structure as the liquid crystal display device in this embodiment as described above except that the electrode structure was different, and by rubbing the alignment film surface, a slight pretilt alignment was given to the vertical direction. The pixel electrode of the liquid crystal display device of Comparative Example 1 had a dot matrix structure with a pixel size of 0.7 mm square. No slit is formed in the pixel, and no formation of sub-pixels like in the liquid crystal display device in this embodiment is made. The panel specific resistance was 1.0×10¹¹ Ωcm.

Using the vertical alignment type liquid crystal display device of Comparative Example 1, static electricity was applied to the substrate surface for displaying the liquid crystal layer, whereby the time until the electrostatic charge was resolved was 15 seconds.

By using this vertical alignment type liquid crystal display device of Comparative Example 1, the above-described evaluation of display irregularities was carried out.

As a result of the evaluation, in the evaluation at a frame frequency of 25 Hz, the evaluation result was x, in the evaluation at a frame frequency of 50 Hz, the evaluation result was x. In the evaluation at a frame frequency of 100 Hz, the evaluation result was Δ, and in the evaluation at a frame frequency of 150 Hz and 200 Hz, each of the evaluation results was ◯.

### Comparative Example 2

A liquid crystal display device of Comparative Example 2 was prepared by applying the above liquid crystal 2 to a conventional vertical alignment type liquid crystal display device having the same structure as the liquid crystal display device in this embodiment as described above except that the electrode structure was different, and by rubbing the alignment film surface, a slight pretilt alignment was given to the vertical direction. The pixel electrode of the liquid crystal display device of Comparative Example 2 had, like in Comparative Example 1, a dot matrix structure with a pixel size of 0.7 mm square. No slit is formed in the pixel, and no formation of sub-pixels like in the liquid crystal display device in this embodiment is made. The panel specific resistance was 4.6×10¹⁰ Ωcm.

Using the vertical alignment type liquid crystal display device of Comparative Example 2, static electricity was applied to the substrate surface for displaying the liquid crystal layer, whereby the time until the electrostatic charge was resolved was 5 seconds.

By using this vertical alignment type liquid crystal display device of Comparative Example 2, the above-described evaluation of display irregularities was carried out.

As a result of the evaluation, in the evaluation at a frame frequency of 25 Hz, 50 Hz, 100 Hz and 150 Hz, the evaluation results were x. In the evaluation at a frame frequency of 200 Hz, the evaluation result was Δ.

### Comparative Example 3

A liquid crystal display device of Comparative Example 3 was prepared by applying the above liquid crystal 3 to a conventional vertical alignment type liquid crystal display device having the same structure as the liquid crystal display device in this embodiment as described above except that the electrode structure was different, and by rubbing the alignment film surface, a slight pretilt alignment was given to the vertical direction. The pixel electrode of the liquid crystal display device of Comparative Example 3 had, like in Comparative Example 1, a dot matrix structure with a pixel size of 0.7 mm square. No slit is formed in the pixel, and no formation of sub-pixels like in the liquid crystal display device in this embodiment is made. The panel specific resistance was 1.1×10¹⁰ Ωcm.

Using the vertical alignment type liquid crystal display device of Comparative Example 3, static electricity was applied to the substrate surface for displaying the liquid crystal layer, whereby the time until the electrostatic charge was resolved was less than 1 second.

By using this vertical alignment type liquid crystal display device of Comparative Example 3, the above-described evaluation of display irregularities was carried out.

As a result of the evaluation, in the evaluation at a frame frequency of 25 Hz, 50 Hz, 100 Hz and 150 Hz, the evaluation results were x. In the evaluation at a frame frequency of 200 Hz, the evaluation result was Δ.

### Comparative Example 4

A liquid crystal display device of Comparative Example 4 was prepared by applying the liquid crystal composition as the base liquid crystal for the above liquid crystals 1 to 3, to a conventional vertical alignment type liquid crystal display device having the same structure as the liquid crystal display device in this embodiment as described above except that the electrode structure was different and a slight pretilt alignment was given to the vertical direction. As mentioned above, this base liquid crystal is a liquid crystal composition which is made of a nematic liquid crystal and which has a liquid crystal temperature range of from −40° C. to +102° C., a dielectric constant anisotropy (Δ∈) at 25° C. being −4.5 and a refractive index anisotropy at 25° C. being 0.180. TDA is not added.

The pixel electrode of the liquid crystal display device of Comparative Example 4 has, like in Comparative Example 1, a dot matrix structure with a pixel size of 0.39 mm square. No slit is formed in the pixel, and no formation of sub-pixels as in the liquid crystal display device in this embodiment is made. The panel specific resistance was 4.4×10¹¹ Ωcm.

By using the vertical alignment type liquid crystal display device of Comparative Example 4, static electricity was applied to the substrate surface for displaying the liquid crystal layer, whereby the time until the electrostatic charge was resolved was 200 seconds and thus was found to be a very long time.

By using this vertical alignment type liquid crystal display device of Comparative Example 4, the above-described evaluation of display irregularities was carried out.

As a result of the evaluation, in the evaluation at a frame frequency of 25 Hz, the evaluation result was x, in the evaluation at a frame frequency of 50 Hz, the evaluation result was x. In the evaluation at a frame frequency of 100 Hz, the evaluation result was Δ, and in the evaluation at a frame frequency of 150 Hz and 200 Hz, each of the evaluation results was ◯.

From the foregoing evaluation results of Examples 1 to 8 and Comparative Examples 1 to 4, it was found that the vertical alignment type liquid crystal display device in this embodiment has an excellent electrostatic charge-resolving property and whereby inherent display irregularities can be reduced, and thus it is suitable for multiplex driving.

Further, the present invention is not limited to the above-described Examples and may be carried out in various modifications within a range not departing from the concept of the present invention.

The entire disclosure of Japanese Patent Application No. 2010-277491 filed on Dec. 13, 2010 including specification, claims, drawings and summary is incorporated herein by reference in its entirety.

### REFERENCE SYMBOLS

1, 30, 40, 200: Liquid crystal display device
2, 206: Liquid crystal layer
3, 34, 44: Liquid crystal
4, 5, 36, 37, 201, 202: Substrate
6, 12, 13, 25, 26, 27, 28, 56, 86, 96, 106, 116: Flow direction
10, 15, 20, 50, 60, 70, 80, 90, 100, 110: Pixel
11: Direction of tilt
21, 22, 23, 24, 55, 65, 75, 85, 95, 105, 115: Sub-pixel
31, 35, 41, 203, 204: Electrode
32, 54, 54a, 54b, 54c, 64, 67, 73, 73a, 73b, 74, 74a, 74b, 77, 83a, 83b, 84a, 84b, 205: Slit
33: Oblique electric field
42: Projection
51, 61, 71, 81, 91, 101, 111: Front electrode
52, 62, 72, 82, 92, 102, 112: Back electrode
93a, 93b, 94a, 94b, 103a, 103b, 104a, 104b, 113a, 113b: Parallel slits
207, 208: Polarizing plate

What is claimed is:

1. A liquid crystal display device having a liquid crystal layer sandwiched by a pair of substrates having an electrode formed on their surface, wherein
the liquid crystal layer is aligned substantially perpendicular to the electrode surface when no voltage is applied, and upon application of a voltage by multiplex driving, the liquid crystal layer in pixels undergoes an alignment change to be aligned parallel to the substrates,
the liquid crystal layer has a specific resistance within a range of from 1×10¹⁰ Ωcm to 2×10¹¹ Ωcm,
by pixel dividing structures provided on the electrode, one pixel is divided into a plurality of sub-pixels, and it is so constructed that as between adjacent sub-pixels interposing a pixel dividing structure, the directions of the alignment change of the liquid crystal layer upon application of a voltage are different, and
the sub-pixels are formed with a pitch within a range of from 50 μm to 100 μm.

2. The liquid crystal display device according to claim 1, wherein the number of divisions of one pixel by the pixel dividing structures is at least 4.

3. The liquid crystal display device according to claim 1, wherein it is so constructed that as between adjacent sub-pixels interposing a pixel dividing structure, the flow directions of liquid crystal in the liquid crystal layer generated by the multiplex driving are different.

4. The liquid crystal display device according to claim 1, wherein the flow direction of liquid crystal in the liquid crystal layer generated by the multiplex driving is equal to the direction of the alignment change of the liquid crystal layer in the sub-pixels.

5. The liquid crystal display device according to claim 1, wherein each pixel dividing structure is either a slit formed in the electrode or a projection formed on the electrode.

6. The liquid crystal display device according to claim 5, wherein polarizing plates are formed, respectively, on surfaces on the sides opposite to the surfaces sandwiching the liquid crystal layer, of the pair of substrates, and the polarizing plates are disposed so that their polarizing axes are perpendicular to each other,
the slit or the projection has a shape extending linearly in the pixel, and the angle between the polarizing axis of either one of the polarizing plates and the extending direction of the slit or the projection is within a range of from 40° to 50°.
